(19) United States
(12) Patent Application Publication
(10) Pub. No.: US 2021/0139029 A1
(43) Pub. Date: May 13, 2021

(54) VEHICLE CONTROL SYSTEM

(71) Applicant: HONDA MOTOR CO., LTD., Tokyo (JP)

(72) Inventors: Ryo YAMAZAKI, Saitama (JP); Yosuke SHIMIZU, Saitama (JP); Takeyuki SUZUKI, Saitama (JP)

(21) Appl. No.: 17/089,815

(22) Filed: Nov. 5, 2020

(30) Foreign Application Priority Data
Nov. 11, 2019 (JP) 2019-203666

(51) Int. Cl. B60W 30/14; B60W 40/08; B60W 60/00

(52) U.S. Cl. CPC B60W 30/146; B60W 40/08; B60W 60/001; B60W 2540/12; B60W 2555/60; B60W 60/0053; B60W 2540/10; B60W 2554/4042

(57) ABSTRACT

A vehicle control system includes: an operation element configured to detect a first operation and a second operation by an occupant; and a control device configured to execute acceleration control, deceleration control, and constant speed control when a vehicle moves forward. The acceleration control is control to accelerate the vehicle in response to the first operation. The deceleration control is control to decelerate the vehicle in response to the second operation. When the first operation ends, the control device sets a vehicle speed at an end of the first operation to a target vehicle speed in a case where a vehicle state does not satisfy a prescribed condition, and sets a prescribed value higher than the vehicle speed at the end of the first operation to the target vehicle speed in a case where the vehicle state satisfies the prescribed condition.

### TECHNICAL FIELD

The present invention relates to a vehicle control system.

### BACKGROUND ART

A vehicle control system known in the art provides a piezoelectric element in a ring of a steering wheel as an operation element, and thus controls acceleration, deceleration, and steering of a vehicle based on the pressure an occupant applies to the ring (for example, JP2018-194916A). In a case where the ring stops detecting the pressure applied by the occupant at a certain timing, the vehicle control system causes the vehicle to travel at a constant speed, which corresponds to a vehicle speed immediately before the above-mentioned certain timing.

In the vehicle control system according to JP2018-194916A, the occupant is required to keep on applying the pressure to the steering wheel until an actual vehicle speed reaches a vehicle speed desired by the occupant. Accordingly, the occupant may be bothered when operating the steering wheel.

### SUMMARY OF THE INVENTION

In view of such a problem of the prior art, a primary object of the present invention is to provide a vehicle control system that enables an occupant to operate an operation element comfortably.

To achieve such an object, one embodiment of the present invention provides a vehicle control system (1) including: an operation element (10) configured to detect a first operation and a second operation by an occupant (X), the first operation being an operation in a first direction, the second operation being an operation in a second direction different from the first direction; and a control device (11) configured to execute acceleration control, deceleration control, and constant speed control when a vehicle moves forward, the acceleration control being control to accelerate the vehicle in response to the first operation, the deceleration control being control to decelerate the vehicle in response to the second operation, the constant speed control being control to accelerate and/or decelerate the vehicle such that a vehicle speed corresponds to a prescribed target vehicle speed in a case where inputs of the first operation and the second operation are absent, wherein when the first operation ends, the control device sets the vehicle speed at an end of the first operation to the target vehicle speed in a case where a vehicle state does not satisfy a prescribed condition, and sets a prescribed value higher than the vehicle speed at the end of the first operation to the target vehicle speed in a case where the vehicle state satisfies the prescribed condition.

According to this configuration, when the first operation ends, the prescribed value higher than the vehicle speed at this time is set to the target vehicle speed in a case where the vehicle state satisfies the prescribed condition. Accordingly, the occupant can end the first operation before an actual vehicle speed reaches a desired vehicle speed in a case where the vehicle state matches a specified vehicle state at a start of the vehicle or the like. Accordingly, the vehicle control system can shorten an operation period of the occupant (namely, a period in which the occupant operates the operation element) and thus enable the occupant to operate the operation element comfortably.

In the above configuration, preferably, in a case where the vehicle speed at a start of the first operation is equal to or less than a prescribed first threshold, the control device sets a recommended vehicle speed to the target vehicle speed.

According to this configuration, in a case where the vehicle speed at the start of the first operation is equal to or less than the first threshold, the vehicle is accelerated until the vehicle speed reaches the recommended vehicle speed even if the occupant ends the first operation relatively early. The first threshold may be set to a value to detect a stopped state or a slowdown state of the vehicle. Accordingly, the vehicle control system can shorten the operation period of the occupant and thus enable the occupant to operate the operation element comfortably.

In the above configuration, preferably, in a case where the vehicle speed at a start of the first operation is equal to or less than a prescribed first threshold and the vehicle speed at the end of the first operation is less than a prescribed recommended vehicle speed, the control device sets the recommended vehicle speed to the target vehicle speed.

According to this configuration, in a case where the vehicle speed at the start of the first operation is equal to or less than the first threshold, the vehicle is accelerated until the vehicle speed reaches the recommended vehicle speed even if the occupant ends the first operation relatively early. The first threshold may be set to a value to detect a stopped state or a slowdown state of the vehicle. Accordingly, the vehicle control system can shorten the operation period of the occupant and thus enable the occupant to operate the operation element comfortably. Further, in a case where the vehicle speed at the end of the first operation is higher than the recommended vehicle speed, the vehicle speed at the end of the first operation is maintained, so that the vehicle speed can match the intention of the occupant.

In the above configuration, preferably, the operation element is configured to move in the first direction from a neutral position in response to the first operation, and in a case where a moving amount of the operation element from the neutral position at the end of the first operation is equal to or more than a prescribed second threshold, the control device sets a recommended vehicle speed to the target vehicle speed.

According to this configuration, the target vehicle speed can be changed according to how the first operation ends. In a case where the occupant ends the first operation quickly, the moving amount of the operation element from the neutral position at the end of the first operation is equal to or more than the second threshold. In such a case, it can be recognized that the occupant does not have an intention of specifying the vehicle speed by himself/herself but has an intention of causing the vehicle control system to accelerate the vehicle to an appropriate vehicle speed. On the other hand, in a case where the occupant ends the first operation slowly, the moving amount of the operation element from the neutral position at the end of the first operation is less than the second threshold. In such a case, it can be recognized that the occupant has an intention of adjusting the vehicle speed by himself/herself.

In the above configuration, preferably, the control device is configured to set the recommended vehicle speed by adding another prescribed value to the vehicle speed at the end of the first operation.

According to this configuration, the recommended vehicle speed is set to a speed higher than the vehicle speed at the end of the first operation by the occupant. Accordingly, the occupant can end the first operation before the vehicle speed reaches a desired vehicle speed.

In the above configuration, preferably, the control device is configured to set the recommended vehicle speed based on at least one of a vehicle speed of another vehicle traveling around the vehicle and a maximum speed set for a road on which the vehicle is traveling.

According to this configuration, the recommended vehicle speed of the vehicle is set to an appropriate value so that the vehicle does not obstruct the traffic.

In the above configuration, preferably, the control device is configured to set the recommended vehicle speed based on the vehicle speed at the past constant speed control.

According to this configuration, the recommended vehicle speed of the vehicle is set to an appropriate value according to the past driving performance of the occupant.

In the above configuration, preferably, the operation element is configured to detect a third operation different from the first operation and the second operation, the third operation being an operation to change the target vehicle speed, wherein in a case where the operation element detects the third operation after the control device sets the recommended vehicle speed to the target vehicle speed, the control device sets one value to the target vehicle speed, the one value being acquired by adding a changing amount corresponding to the third operation to the vehicle speed at detection of the third operation.

According to this configuration, in a case where the occupant performs the third operation, the target vehicle speed is set so as to correspond to the third operation. Accordingly, the intention of the occupant can be reflected in the target vehicle speed.

In the above configuration, preferably, the operation element is configured to move in the first direction from a neutral position in response to the first operation, and the control device is configured to set the recommended vehicle speed higher as a moving amount of the operation element from the neutral position at the end of the first operation increases.

According to this configuration, in a case where the operation amount of the first operation by the occupant is large, the recommended vehicle speed is set to a higher value. In a case where the operation amount of the operation element by the occupant is large, the occupant is considered to hope for a larger change in vehicle speed. Accordingly, by setting the recommended vehicle speed higher, the vehicle control can match the intention of the occupant.

Thus, according to the above configurations, it is possible to provide a vehicle control system that enables an occupant to operate an operation element comfortably.

### BRIEF DESCRIPTION OF THE DRAWINGS

FIG. 1 is a block diagram of a vehicle control system according to an embodiment of the present invention;

FIG. 2 is a plan view of a front part of a vehicle;

FIG. 3 is a perspective view of the front part of the vehicle;

FIG. 4 is a side view of an operation element and a moving device;

FIG. 5 is a rear view of the operation element and the moving device;

FIG. 6 is an explanatory diagram showing a positional relationship among first to third capacitive sensors provided in the operation element;

FIG. 7 is a sectional view of the operation element taken along a line VII-VII of FIG. 5; and

FIG. 8 is a flowchart showing a procedure of acceleration/deceleration control.

### DESCRIPTION OF THE PREFERRED EMBODIMENT(S)

In the following, an embodiment of a vehicle control system 1 according to the present invention will be described with reference to the drawings. Arrows Fr, Re, L, R, U, and Lo, which are appropriately attached to FIG. 2 and subsequent drawings, respectively indicate a front side, a rear side, a left side, a right side, an upper side, and a lower side of a vehicle 2 in which the vehicle control system 1 is provided. In the present embodiment, the lateral direction is defined as the vehicle width direction of the vehicle 2, and the fore and aft direction is defined as the vehicle length direction of the vehicle 2.

### The Configuration of the Vehicle Control System 1

As shown in FIG. 1, the vehicle control system 1 is provided in a vehicle 2 which is capable of autonomous driving. The vehicle 2 can travel either in a manual driving mode in which an occupant X mainly performs a driving operation or in an autonomous driving mode in which the vehicle 2 (more specifically, an undermentioned control device 11) mainly performs the driving operation. The vehicle 2 includes a steering device 4 configured to steer wheels of the vehicle 2, a drive device 5 configured to rotate the wheels, and a brake device 6 configured to apply the brakes to the wheels.

The steering device 4 is a device configured to change a steering angle of the wheels, and includes an electric motor and a steering mechanism configured to steer the wheels by a driving force of the electric motor. The steering mechanism includes, for example, a rack-and-pinion mechanism. The drive device 5 is a device configured to rotate the wheels, and includes at least one of an electric motor and an internal combustion engine. The drive device 5 further includes a transmission mechanism configured to transmit a driving force of the at least one of the electric motor and the internal combustion engine to the wheels. If the drive device 5 includes the internal combustion engine, the drive device 5 can apply the brakes to the wheels by engine braking. If the drive device 5 includes the electric motor, the drive device 5 can apply the brakes to the wheels by regenerative braking. The brake device 6 is a device configured to apply resistance to the wheels and thus stop the rotation of the wheels. The brake device 6 includes an electric motor, a hydraulic pressure generating device configured to generate hydraulic pressure as the electric motor is driven, and a brake caliper that presses a brake pad against a brake rotor on receiving the hydraulic pressure from the hydraulic pressure generating device.

The vehicle control system 1 includes an operation element 10 provided with various sensors and a control device 11 connected to the operation element 10. The operation element 10 is a device configured to receive a driving operation by the occupant X to steer the vehicle 2. The operation element 10 may include, for example, a steering wheel or a control stick. An outline of the operation element 10 may be formed in a shape such as a circular shape, a rectangular shape, a shape formed by cutting off a part of a circle, or a shape formed by combining left and right arc parts and upper and lower straight-line parts. The control device 11 includes a hardware processor such as a CPU. The control device 11 includes a travel control unit 12, a movement control unit 13, and a signal processing unit 14. The signal processing unit 14 is configured to detect an operation input by the occupant X based on a signal from the operation element 10, and the travel control unit 12 is configured to control at least one of the steering device 4, the drive device 5, and the brake device 6 according to the operation input detected by the signal processing unit 14. The movement control unit 13 is configured to control the movement of the operation element 10 according to the operation input detected by the signal processing unit 14.

As shown in FIGS. 2 and 3, a vehicle cabin 17 of the vehicle 2 is provided with an occupant seat 61 on which at least one occupant X (two occupants X are shown in FIG. 2) that performs the driving operation on the operation element 10 is seated. The occupant seat 61 is, for example, a bench seat having a seating space for plural persons, and extends along the lateral direction. By using such a bench seat as the occupant seat 61 in this way, a degree of flexibility in the seating position of the occupant X in the lateral direction can be increased. The occupant seat 61 is attached to a front part of a vehicle body 15 of the vehicle 2 via a base member (not shown). The occupant seat 61 includes a seat cushion 62 on which the occupant X is seated and a seat back 63 provided adjacently to the seat cushion 62 on an upper rear side thereof so as to support the occupant X from a rear side. The seat cushion 62 and the seat back 63 each have a prescribed width in the lateral direction (for example, a width for plural occupants X).

As shown in FIGS. 3 and 4, the operation element 10 is supported by the front part of the vehicle body 15 via a moving device 16. The moving device 16 includes a pair of front and rear rails 21 provided on the front part of the vehicle body 15 and extending in the lateral direction, a slider 22 extending in the fore and aft direction so as to be provided between the pair of front and rear rails 21, an arm 23 extending rearward from the slider 22, and a base 24 provided at a rear end of the arm 23 and attached to the operation element 10.

The pair of front and rear rails 21 support the slider 22 such that the slider 22 is movable in the lateral direction. The pair of front and rear rails 21 and the slider 22 are provided in front of an instrument panel 18 that forms a front wall of the vehicle cabin 17 of the vehicle 2. Accordingly, the pair of front and rear rails 21 and the slider 22 are invisible or hardly seen from the occupant X in the vehicle cabin 17 of the vehicle 2, so that the design of the vehicle 2 is improved.

The arm 23 includes joints 25, and passes below the instrument panel 18 in a state where the joints 25 are bent such that the arm 23 protrudes downward. The arm 23 is stretchable in the fore and aft direction, and thereby supporting the base 24 such that the base 24 is movable in the fore and aft direction with respect to the slider 22.

An image capturing device 26 configured to capture an image of a space above the seat cushion 62 is provided on an upper surface of the base 24. The image capturing device 26 is positioned in front of the operation element 10 so as to be adjacent to the operation element 10.

As shown in FIG. 1, the moving device 16 includes a slider driving mechanism 27 and an arm driving mechanism 28. The slider driving mechanism 27 is configured to move the slider 22 in the lateral direction with respect to the rails 21 by an electric motor. Thereby, the slider 22, the arm 23, the base 24, and the operation element 10 move in the lateral direction with respect to the vehicle body 15. The arm driving mechanism 28 is configured to change a stretching degree of the arm 23 in the fore and aft direction by bending the joints 25 with an electric motor. Thereby, the base 24 and the operation element 10 move in the fore and aft direction with respect to the vehicle body 15. As described above, the moving device 16 is configured to move the operation element 10 in the lateral direction and the fore and aft direction with respect to the vehicle body 15.

The moving device 16 further includes a position sensor 29 configured to detect a position of the operation element 10 in the fore and aft direction. For example, the position sensor 29 is attached to the electric motor that forms the arm driving mechanism 28, or to one of the joints 25 of the arm 23. The position sensor 29 may be, for example, a potentiometer or a rotary encoder.

As shown in FIGS. 3 to 5, the operation element 10 includes a hub 31 provided rotatably on the base 24, a disk 32 (a spoke) provided coaxially with the hub 31 on an outer circumference of the hub 31, and a ring 33 provided on an outer circumference of the disk 32. The disk 32 is formed in a circular plate shape. In the present embodiment, the disk 32 extends radially outward from the hub 31 to a side opposite to the base 24 in a direction of a turning axis A of the operation element 10 (the hub 31), and is formed in a cone shape with the hub 31 on the top thereof. The ring 33 is formed in an annular shape around the turning axis A of the operation element 10 (the hub 31), and has a circular cross section. The cross-sectional diameter of the ring 33 is larger than the thickness of the disk 32. The ring 33 functions as a grip portion gripped by the occupant X to perform a turning operation on the operation element 10.

The hub 31 includes a facing part 31A facing a side of the occupant X and a back part (not shown) opposite to the facing part 31A. The disk 32 includes a facing part 32A facing the side of the occupant X and a back part 32B opposite to the facing part 32A. The ring 33 includes a facing part 33A facing the side of the occupant X, a back part 33B opposite to the facing part 33A, an outer circumferential part 33C provided on outer circumferences of the facing part 33A and the back part 33B, and an inner circumferential part 33D provided on inner circumferences of the facing part 33A and the back part 33B. More specifically, when the ring 33 is divided into two parts with a plane including an outer circumferential edge of the ring 33 (a part where the ring 33 has a maximum diameter around the turning axis A of the operation element 10) and an inner circumferential edge of the ring 33 (a part where the ring 33 has a minimum diameter around the turning axis A of the operation element 10), a part arranged on a side of the base 24 is defined as the back part 33B, while a part arranged on a side opposite to the base 24 is defined as the facing part 33A.

The operation element 10 includes a first surface part 10A, a second surface part 10B opposite to the first surface part 10A, and an outer circumferential part 10C provided on outer circumferences of the first surface part 10A and the second surface part 10B. The first surface part 10A is provided on one side along the turning axis A of the operation element 10, and forms a rear surface (one surface in the fore and aft direction) of the operation element 10. The second surface part 10B is provided on the other side along the turning axis A of the operation element 10, and forms a front surface (the other surface in the fore and aft direction) of the operation element 10. The first surface part 10A includes the facing part 31A of the hub 31, the facing part 32A of the disk 32, and the facing part 33A of the ring 33. The second surface part 10B includes the back part 32B of the disk 32 and the back part 33B of the ring 33. The outer circumferential part 10C includes the outer circumferential part 33C of the ring 33. In another embodiment, the first surface part 10A may include the back part 32B of the disk 32 and the back part 33B of the ring 33, and the second surface part 10B may include the facing part 31A of the hub 31, the facing part 32A of the disk 32, and the facing part 33A of the ring 33.

As shown in FIG. 1, the operation element 10 is provided with a first capacitive sensor 35, a second capacitive sensor 36, and third capacitive sensors 37, which function as touch sensors (contact sensors). The operation element 10 is also provided with a turning angle sensor 38 and a force sensor 39. The turning angle sensor 38 is configured to detect a turning angle of the operation element 10 with respect to the vehicle body 15. The turning angle sensor 38 may be a rotary encoder, a resolver, or the like. In another embodiment, the operation element 10 may be provided with a gyro sensor configured to detect the turning speed of the operation element 10.

The force sensor 39 may be a known piezoelectric sensor or a known strain gauge sensor, and is provided between the base 24 and the hub 31. The force sensor 39 is, for example, a six-axis force sensor configured to detect the loads applied to the operation element 10 to the front side along the turning axis A (one side in the fore and aft direction), to the rear side along the turning axis A (the other side in the fore and aft direction), to the left side (the first side in the lateral direction), to the right side (the second side in the lateral direction), to the upper side along a direction orthogonal to the turning axis A (one side in the up-and-down direction), and to the lower side along the direction orthogonal to the turning axis A (the other side in the up-and-down direction).

As shown in FIGS. 4, 6, and 7, the first to third capacitive sensors 35 to 37 are touch sensors configured to detect approach and contact of an object such as the occupant X's hand (finger) according to a change in capacitance. The first to third capacitive sensors 35 to 37 are provided on the ring 33 of the operation element 10.

The first capacitive sensor 35 is provided on the first surface part 10A of the operation element 10, the second capacitive sensor 36 is provided on the second surface part 10B of the operation element 10, and the third capacitive sensors 37 are provided on the outer circumferential part 10C of the operation element 10. More specifically, the first capacitive sensor 35 is provided on the facing part 33A of the ring 33, the second capacitive sensor 36 is provided on the back part 33B of the ring 33, and the third capacitive sensors 37 are provided on the outer circumferential part 33C of the ring 33. In another embodiment, the first capacitive sensor 35 may be provided on the back part 33B of the ring 33, and the second capacitive sensor 36 may be provided on the facing part 33A of the ring 33.

The first capacitive sensor 35 is a single sensor formed in an annular shape and provided coaxially with the ring 33 along the facing part 33A of the ring 33. In another embodiment, plural first capacitive sensors 35 may be arranged in the circumferential direction along the facing part 33A of the ring 33. The first capacitive sensor 35 is preferably provided on an inner circumferential side of the facing part 33A. More specifically, when viewed in the direction along the turning axis A of the operation element 10, the first capacitive sensor 35 is preferably provided on a radially inner side with respect to a center circle that passes through a widthwise central part of the ring 33. Namely, the first capacitive sensor 35 is preferably provided on the inner circumferential part 33D of the ring 33.

The second capacitive sensor 36 is a single sensor formed in an annular shape and provided coaxially with the ring 33 along the back part 33B of the ring 33. In another embodiment, plural second capacitive sensors 36 may be arranged in the circumferential direction along the back part 33B of the ring 33. The second capacitive sensor 36 preferably extends along a widthwise central part of the back part 33B. The second capacitive sensor 36 preferably has a larger diameter than the first capacitive sensor 35.

The third capacitive sensors 37 are provided along an outer edge of the operation element 10 and configured to identify a contact position of the hand of the occupant X (a position of a contact operation by the occupant X). In another embodiment, a single third capacitive sensor 37 may extend along the outer edge of the operation element 10, or plural third capacitive sensors 37 may be divided along the outer edge of the operation element 10. In the present embodiment, the third capacitive sensors 37 are arranged in the circumferential direction along the outer circumferential part 33C of the ring 33, which includes the outer circumferential edge of the ring 33. The third capacitive sensors 37 each have the same angular length in the circumferential direction, and are arranged adjacently to each other at equal intervals. Preferably, the gaps between the adjacent third capacitive sensors 37 are as small as possible. In the present embodiment, thirty-six third capacitive sensors 37 each having an angular length of about 10 degrees are provided.

The first to third capacitive sensors 35 to 37 are configured to output signals corresponding to the capacitance thereof. The capacitance of the first to third capacitive sensors 35 to 37 increases as the object such as the occupant X's hand approaches the respective sensors 35 to 37, as the size of the approaching object increases, and as the relative permittivity of the approaching object increases.

The first to third capacitive sensors 35 to 37 function as grip sensors configured to detect that the operation element 10 is gripped by the occupant X. For example, the first to third capacitive sensors 35 to 37 detect that the operation element 10 is gripped by the occupant X if the capacitance of at least one of the first capacitive sensor 35 and the second capacitive sensor 36 has increased to a prescribed reference value or more and the capacitance of the third capacitive sensors 37 equal to or more than a prescribed number has increased to the prescribed reference value or more. In another embodiment, the first to third capacitive sensors 35 to 37 may be configured to detect that the operation element 10 is gripped by the occupant X according to a detecting method different from the above method.

As shown in FIG. 5, a display 40 as a display unit is provided on the facing part 31A of the hub 31 (a side of the occupant X of the hub 31). The display 40 is formed in a circular shape and occupies 50% or more of the area of the facing part 31A of the hub 31. As shown in FIG. 1, the display 40 is configured to be controlled by an interface control unit 41 of the control device 11, thereby displaying images indicating a driving mode (the autonomous driving mode or the manual driving mode) of the vehicle 2, a travel direction (a future trajectory) of the vehicle 2, the position of a surrounding vehicle traveling around the vehicle 2, the speed of the vehicle 2, or the like. The images displayed on the display 40 may include numerical values and symbols.

A first reaction force applying device 43 (see FIG. 1) configured to apply a reaction force (turning resistance) to the turning (or the turning operation) of the operation element 10 with respect to the vehicle body 15 is provided between the vehicle body 15 and the operation element 10. The first reaction force applying device 43 is, for example, an electric motor, and configured to apply a rotational force of the electric motor to the operation element 10 as the reaction force to the turning of the operation element 10. In the present embodiment, the first reaction force applying device 43 is provided in the base 24, and configured to apply the reaction force to the turning of the hub 31 with respect to the base 24. The first reaction force applying device 43 can restrict the turning of the operation element 10 by applying sufficient turning resistance to the operation element 10. Namely, the first reaction force applying device 43 functions as a turning restriction device configured to restrict the turning of the operation element 10 with respect to the vehicle body 15.

A second reaction force applying device 44 (see FIG. 1) configured to apply a reaction force (movement resistance) to the movement (or the moving operation) of the operation element 10 along the turning axis A with respect to the vehicle body 15 is provided between the vehicle body 15 and the operation element 10. The second reaction force applying device 44 is, for example, the electric motor that forms the arm driving mechanism 28, and configured to apply a rotational force of the electric motor to the operation element 10 as the reaction force to the movement of the operation element 10 in the fore and aft direction. The second reaction force applying device 44 can restrict the movement of the operation element 10 in the fore and aft direction by applying sufficient movement resistance to the operation element 10. Namely, the second reaction force applying device 44 functions as a movement restriction device configured to restrict the movement of the operation element 10 in the fore and aft direction with respect to the vehicle body 15.

As shown in FIG. 1, the control device 11 is connected to a vehicle sensor 45 configured to detect various state quantities of the vehicle 2 and an external environment recognizing device 46 configured to detect environmental information around the vehicle 2. The vehicle sensor 45 includes, for example, a vehicle speed sensor configured to detect the vehicle speed (namely, the speed of the vehicle 2), an acceleration sensor configured to detect the acceleration of the vehicle 2, and a yaw rate sensor configured to detect the yaw rate of the vehicle 2. The control device 11 is configured to acquire the various state quantities of the vehicle 2 from the vehicle sensor 45.

The external environment recognizing device 46 is configured to acquire surrounding vehicle information and surrounding environment information, thereby outputting the surrounding vehicle information and the surrounding environment information to the control device 11. The external environment recognizing device 46 includes a camera 47 configured to capture an image around the vehicle 2, an object detection sensor 48 such as a laser or a lidar configured to detect an object present around the vehicle 2, and a navigation device 49. The external environment recognizing device 46 is configured to identify lanes (travel trajectories) and lane markings based on the image captured by the camera 47. Also, the external environment recognizing device 46 is configured to acquire the surrounding vehicle information, which includes information about the position and the speed of the surrounding vehicle traveling around the vehicle 2, based on the image captured by the camera 47 and a detection signal of the object detection sensor 48. Also, the external environment recognizing device 46 is configured to acquire the surrounding environment information, which includes information about a first travel path where the vehicle is traveling, a second travel path adjacent to the first travel path, stores around the vehicle 2, and branch roads around the vehicle 2, based on the position of the vehicle 2 (namely, the own vehicle), map information, and Point of Interest (POI) acquired by the navigation device 49.

### The Driving Operation on the Operation Element 10

The operation element 10 is configured to receive a first driving operation and a second driving operation as the driving operation. The first driving operation and the second driving operation each include an acceleration/deceleration operation and a steering operation different from each other. The first driving operation is a driving operation performed by touching the operation element 10 (for example, a single tap operation, a double tap operation, a long press operation, and a stroke operation). Accordingly, the movable amount of the operation element 10 according to the first driving operation is zero or extremely small. The second driving operation is a driving operation performed by turning or moving the operation element 10. Accordingly, the movable amount of the operation element 10 according to the second driving operation is larger than that of the operation element 10 according to the first driving operation. In this way, the first driving operation is a contact operation on the operation element 10, while the second driving operation is a turning operation or a moving operation on the operation element 10. Accordingly, it is possible to clearly distinguish the first driving operation and the second driving operation and avoid confusion between the two.

The first driving operation includes a stroke operation in the circumferential direction on the outer circumferential part 33C of the ring 33 by the hand of the occupant X. When the hand of the occupant X strokes the outer circumferential part 33C of the ring 33 in the circumferential direction, the capacitance of the third capacitive sensors 37 arranged in the circumferential direction changes sequentially. The signal processing unit 14 detects the stroke operation on the ring 33 by the occupant X based on the signals from the third capacitive sensors 37. Also, the signal processing unit 14 detects the direction and the length (stroke length) of the stroke operation based on the signals from the third capacitive sensors 37. The travel control unit 12 may control the steering device 4 according to the direction and the length of the stroke operation detected by the signal processing unit 14, thereby moving (offsetting) the vehicle 2 in the vehicle width direction, changing the lanes, and turning the vehicle 2 right or left.

Further, the first driving operation includes the contact operation on the facing part 33A or the back part 33B of the ring 33 by the occupant X. The contact operation includes, for example, a single tap operation, a double tap operation, and a long press operation. When the hand of the occupant X performs the contact operation on the facing part 33A or the back part 33B of the ring 33, the capacitance of the first capacitive sensor 35 or the second capacitive sensor 36 changes. The signal processing unit 14 determines the contact duration and the contact number of the hand of the occupant X based on the detection signal from the first capacitive sensor 35 or the second capacitive sensor 36, thereby determining whether the contact operation is either of a single tap operation, a double tap operation, and a long press operation.

For example, the travel control unit 12 executes the acceleration control in response to the operation on the facing part 33A, and executes the deceleration control in response to the operation on the back part 33B. The acceleration control includes the control to increase the target speed of the vehicle 2 by a predetermined value from the current value, the control to decrease the target vehicle-to-vehicle distance (namely, the distance between the vehicle 2 (namely, the own vehicle) and the preceding vehicle traveling in front of the vehicle 2) by a predetermined value from the current value, and the control to start the movement of the vehicle 2 from a state where the vehicle 2 is stopped. The deceleration control includes the control to decrease the target speed of the vehicle 2 by a predetermined value from the current value, the control to increase the target vehicle-to-vehicle distance by a predetermined value from the current value, and the control to stop the vehicle 2 from a state where the vehicle 2 is traveling at low speed. The travel control unit 12 may change the control to execute or the changing amount of the target speed of the vehicle 2 according to the mode of the operation on the facing part 33A or the back part 33B. For example, the travel control unit 12 may make the changing amount of the target speed of the vehicle 2 in response to a double tap operation larger than that of the target speed of the vehicle 2 in response to a single tap operation. Also, the travel control unit 12 may keep on increasing or decreasing the target speed of the vehicle 2 while a long press operation is being performed on the facing part 33A or the back part 33B.

The second driving operation includes the turning operation on the operation element 10 around the turning axis A and the moving operation (push/pull operation) on the operation element 10 along the turning axis A. When the occupant X performs the turning operation on the operation element 10, the turning angle sensor 38 detects the turning angle of the operation element 10 with respect to the vehicle body 15. The signal processing unit 14 acquires the turning angle of the operation element 10 based on the detection signal from the turning angle sensor 38, and the travel control unit 12 controls the steering device 4 according to the acquired turning angle, thereby steering the wheels of the vehicle 2.

When the occupant X performs the moving operation on the operation element 10 to the front side (namely, when the occupant X pushes the operation element 10), the force sensor 39 detects the load applied to the operation element 10 to the front side. The signal processing unit 14 acquires the load applied to the operation element 10 and the direction of the load based on the detection signal from the force sensor 39, and the travel control unit 12 controls the drive device 5 according to the acquired load and the acquired direction of the load, thereby accelerating the vehicle 2. When the occupant X performs the moving operation on the operation element 10 to the rear side (namely, when the occupant X pulls the operation element 10), the force sensor 39 detects the load applied to the operation element 10 to the rear side. The signal processing unit 14 acquires the load applied to the operation element 10 and the direction of the load based on the detection signal from the force sensor 39, and the travel control unit 12 controls at least one of the drive device 5 and the brake device 6 according to the acquired load and the acquired direction of the load, thereby decelerating the vehicle 2. In another embodiment, the position sensor 29 may detect the moving operation on the operation element 10 by the occupant X, and the travel control unit 12 may execute the acceleration/deceleration control of the vehicle 2 based on the signal from the position sensor 29.

### The Driving Mode of the Vehicle 2

The travel control unit 12 is configured to switch the driving mode of the vehicle 2 between the autonomous driving mode and the manual driving mode. In the autonomous driving mode, the travel control unit 12 automatically executes the steering operation and the acceleration/deceleration operation. In the manual driving mode, the occupant X manually performs the steering operation and the acceleration/deceleration operation.

In the autonomous driving mode, the travel control unit 12 independently creates a future trajectory of the vehicle 2, thereby controlling the steering device 4, the drive device 5, and the brake device 6. However, even in the autonomous driving mode, the travel control unit 12 receives the first driving operation on the operation element 10 by the occupant X, thereby causing the control of the steering device 4, the drive device 5, and the brake device 6 to reflect the intention of the occupant X. That is, the first driving operation is an auxiliary driving operation in the autonomous driving mode.

In the manual driving mode, the travel control unit 12 controls the steering device 4, the drive device 5, and the brake device 6 according to the second driving operation on the operation element 10 by the occupant X. That is, the second driving operation is an independent driving operation in the manual driving mode. In another embodiment, in the manual driving mode, the travel control unit 12 may control the drive device 5 and the brake device 6 according to a pressing operation on an accelerator pedal or a brake pedal by the occupant X.

### The Position of the Operation Element 10

With reference to FIG. 2, the operation element 10 is movable among a first position P1 as an allowance position, a second position P2 as an allowance position, and a third position P3 as a restriction position. The first position P1 is located on the left side (the first side in the lateral direction) with respect to the center of the vehicle 2 in the lateral direction, and the second position P2 is located on the right side (the second side in the lateral direction) with respect to the center of the vehicle 2 in the lateral direction. That is, the first position P1 and the second position P2 are offset from each other in the lateral direction and separated from each other. The third position P3 is located at the center of the vehicle 2 in the lateral direction. The third position P3 is located between the first position P1 and the second position P2 in the lateral direction (more specifically, located in the middle of the first position P1 and the second position P2 in the lateral direction), and is offset from the first position P1 and the second position P2 in the lateral direction. The third position P3 is located more forward than the first position P1 and the second position P2 in the fore and aft direction. Accordingly, when the occupant X does not operate the operation element 10 (for example, when the autonomous driving mode is executed or when the occupant X gets on or off the vehicle 2), the operation element 10 is moved to the third position P3, so that the operation element 10 and the occupant X can be separated from each other. Accordingly, it is possible to prevent the operation element 10 from oppressing the occupant X.

In a state where the operation element 10 is located in the first position P1 or the second position P2, the vehicle 2 can travel in the autonomous driving mode and the manual driving mode. More specifically, in a state where the operation element 10 is located in the first position P1 or the second position P2, the travel control unit 12 switches the driving mode of the vehicle 2 between the manual driving mode and the autonomous driving mode according to an operation on a mode change switch 51 (see FIG. 1) by the occupant X. In a state where the operation element 10 is located in the third position P3, the vehicle 2 can travel only in the autonomous driving mode, and the manual driving mode cannot be selected. In a state where the operation element 10 is located between the first position P1 and the third position P3 or between the second position P2 and the third position P3, the vehicle 2 can travel only in the autonomous driving mode, and the manual driving mode cannot be selected.

In a state where the operation element 10 is located in the first position P1 or the second position P2, the operation element 10 can receive both the first driving operation and the second driving operation. More specifically, in a state where the operation element 10 is located in the first position P1 or the second position P2 and the driving mode of the vehicle 2 is set to the autonomous driving mode, the operation element 10 can receive the first driving operation. On the other hand, in a state where the operation element 10 is located in the first position P1 or the second position P2 and the driving mode of the vehicle 2 is set to the manual driving mode, the operation element 10 can receive the second driving operation.

In a state where the operation element 10 is located in the third position P3, between the first position P1 and the third position P3, or between the second position P2 and the third position P3, the driving mode of the vehicle 2 is set to the autonomous driving mode, and the operation element 10 can receive the first driving operation and cannot receive the second driving operation. Thus, in the third position P3 where the operation element 10 and the occupant X are separated from each other, it is possible to prevent the execution of the second driving operation, which makes the movable amount of the operation element 10 relatively large. Accordingly, it is possible to prevent an erroneous operation on the operation element 10 located in the third position P3.

### The Acceleration/Deceleration Control in the Manual Driving Mode

In the following, the details of the acceleration/deceleration control the control device 11 executes in the manual driving mode will be described. As described above, the travel control unit 12 of the control device 11 executes the acceleration/deceleration control based on the signal from the operation element 10. The operation element 10 is configured to detect a first operation and a second operation by the occupant X. The first operation is an operation in a first direction, and the second operation is an operation in a second direction different from the first direction. In the present embodiment, the first direction is directed forward along the turning axis A, and the first operation is an operation to push the operation element 10 forward along the turning axis A. Further, the second direction is directed rearward along the turning axis A, and the second operation is an operation to pull the operation element 10 rearward along the turning axis A.

The force sensor 39 of the operation element 10 is configured to detect the first operation and the second operation by the occupant X. The control device 11 is configured to detect the first operation and the second operation by the occupant X based on the signal from the force sensor 39. Alternatively, the control device 11 may be configured to detect the first operation and the second operation by the occupant X based on the position of the operation element 10 in the fore and aft direction detected by the position sensor 29.

The travel control unit 12 of the control device 11 executes the acceleration control when the vehicle 2 moves forward. The acceleration control is the control to accelerate the vehicle 2 in response to the first operation. Further, the travel control unit 12 of the control device 11 executes the deceleration control when the vehicle 2 moves forward. The deceleration control is the control to decelerate the vehicle 2 in response to the second operation. Further, the travel control unit 12 of the control device 11 executes constant speed control when the vehicle 2 moves forward. The constant speed control is the control to accelerate and/or decelerate the vehicle 2 such that the vehicle speed corresponds to (matches with) a prescribed target vehicle speed in a case where inputs of the first operation and the second operation are absent.

The travel control unit 12 executes the acceleration control while the force sensor 39 is detecting a forward load (namely, while the first operation is being detected). In the acceleration control, the travel control unit 12 controls the drive device 5, thereby accelerating the vehicle 2. In the acceleration control, the travel control unit 12 continues accelerating the vehicle 2. Accordingly, while the occupant X is performing the first operation (namely, while the occupant X is pushing the operation element 10 forward), the vehicle 2 continues accelerating. In the acceleration control, the travel control unit 12 may increase the acceleration of the vehicle 2 as the value of the forward load detected by the force sensor 39 becomes larger. Alternatively, in the acceleration control, the travel control unit 12 may increase the acceleration of the vehicle 2 as a forward moving amount of the operation element 10 from a neutral position detected by the position sensor 29 becomes larger. In a case where the operation element 10 stops detecting the first operation by the occupant X (namely, in a case where the first operation ends) during the acceleration control, the travel control unit 12 ends the acceleration control.

The travel control unit 12 executes the deceleration control while the force sensor 39 is detecting a rearward load (namely, while the second operation is being detected). In the deceleration control, the travel control unit 12 controls the drive device 5 and/or the brake device 6, thereby decelerating the vehicle 2. In the deceleration control, the travel control unit 12 continues decelerating the vehicle 2. Accordingly, while the occupant X is performing the second operation (namely, while the occupant X is pulling the operation element 10 rearward), the vehicle 2 continues decelerating. In the deceleration control, the travel control unit 12 may increase the deceleration of the vehicle 2 as the value of the rearward load detected by the force sensor 39 becomes larger. Alternatively, in the deceleration control, the travel control unit 12 may increase the deceleration of the vehicle 2 as a rearward moving amount of the operation element 10 from the neutral position detected by the position sensor 29 becomes larger. In a case where the operation element 10 stops detecting the second operation by the occupant X (namely, in a case where the second operation ends) during the deceleration control, the travel control unit 12 ends the deceleration control.

When the force sensor 39 is not detecting either the forward load and the rearward load (namely, when the operation element 10 does not detect either the first operation and the second operation), the travel control unit 12 executes the constant speed control. In the constant speed control, the travel control unit 12 sets the target vehicle speed, controls the drive device 5 and/or the brake device 6 such that the vehicle speed corresponds to (matches with) the target vehicle speed, and causes the vehicle 2 to travel at the target vehicle speed. When the first operation ends, the travel control unit 12 sets the vehicle speed at the end of the first operation to the target vehicle speed in a case where a vehicle state does not satisfy a prescribed condition, and sets a prescribed value higher than the vehicle speed at the end of the first operation to the target vehicle speed in a case where the vehicle state satisfies the prescribed condition. The travel control unit 12 is configured to acquire the ending time of the first operation based on the signal from the force sensor 39.

For example, the above-mentioned prescribed condition includes a first condition. The first condition is a condition that the vehicle speed at the start of the first operation is equal to or less than a prescribed first threshold. The first threshold is a threshold set for determining whether the vehicle 2 is in a stopped state or a slowdown state. For example, the first threshold is set to a value between 5 km/h and 10 km/h. Namely, in a case where the occupant X performs the first operation (acceleration operation) when the vehicle 2 is in the stopped state or the slowdown state, the first condition is satisfied. For example, when the vehicle 2 starts moving from the stopped state or when the vehicle 2 gets out of a traffic jam and thus accelerates, the first condition may be satisfied.

The prescribed condition may also include a second condition in addition to the first condition. The second condition is a condition that the vehicle speed at the end of the first operation is less than a prescribed recommended vehicle speed.

Further, the prescribed condition may include a third condition. The third condition is a condition that the moving amount of the operation element 10 from the neutral position at the end of the first operation is equal to or more than a prescribed second threshold. In a case where the occupant X ends the first operation quickly, the moving amount of the operation element 10 from the neutral position at the end of the first operation is probably equal to or more than the second threshold. In such a case, it can be recognized that the occupant X does not have an intention of specifying the vehicle speed by himself/herself but has an intention of causing the vehicle control system 1 to accelerate the vehicle 2 to an appropriate vehicle speed. On the other hand, in a case where the occupant X ends the first operation slowly, the moving amount of the operation element 10 from the neutral position at the end of the first operation is probably less than the second threshold. In such a case, it can be recognized that the occupant X has an intention of adjusting the vehicle speed by himself/herself.

The above-mentioned recommended vehicle speed is a vehicle speed suitable for the road on which the vehicle 2 is traveling at present. The recommended vehicle speed may be set based on at least one of a vehicle speed of another vehicle traveling around the vehicle 2 and a maximum speed (speed limit) set for the road on which the vehicle 2 is traveling. A recommended vehicle speed setting unit 81 of the control device 11 may acquire the above-mentioned maximum speed based on the current position of the vehicle 2 and the map information acquired by the navigation device 49. Further, the travel control unit 12 may acquire the above vehicle speed of another vehicle by using the external environment recognizing device 46. The recommended vehicle speed setting unit 81 may set the above-mentioned maximum speed or the above-mentioned vehicle speed of another vehicle to the recommended vehicle speed. Accordingly, the recommended vehicle speed of the vehicle 2 is set to an appropriate value so that the vehicle 2 does not obstruct the traffic.

In another embodiment, the recommended vehicle speed setting unit 81 may set the recommended vehicle speed based on the vehicle speed at the past constant speed control. The vehicle speed at the past constant speed control may be stored in a storage device included in the control device 11.

The recommended vehicle speed setting unit 81 of the control device 11 may set the recommended vehicle speed higher as the moving amount of the operation element 10 from the neutral position at the end of the first operation increases. For example, the recommended vehicle speed setting unit 81 may set (acquire) the recommended vehicle speed by multiplying the above-mentioned maximum speed and a coefficient together or by multiplying the above-mentioned vehicle speed of another vehicle and the coefficient together. The coefficient corresponds to the moving amount of the operation element 10 from the neutral position at the end of the first operation. The recommended vehicle speed setting unit 81 may acquire the moving amount of the operation element 10 from the neutral position at the end of the first operation based on the signal from the position sensor 29. Thus, in a case where the operation amount of the first operation by the occupant X is large, the recommended vehicle speed is set to a higher value. In a case where the operation amount of the operation element 10 by the occupant X is large, the occupant X is considered to hope for a larger change in the vehicle speed. Accordingly, by setting the recommended vehicle speed higher, the vehicle control can match the intention of the occupant X.

In a case where the first condition is not satisfied at the start of the constant speed control (at the end of the first operation), the travel control unit 12 sets the vehicle speed at the end of the first operation to the target vehicle speed and controls the drive device 5 and/or the brake device 6 such that the vehicle speed corresponds to the target vehicle speed. As the travel control unit 12 executes the constant speed control, the vehicle speed of the vehicle 2 is maintained at the vehicle speed at the end of the first operation.

In a case where the first condition is satisfied at the start of the constant speed control (at the end of the first operation), the travel control unit 12 sets the recommended vehicle speed to the target vehicle speed and controls the drive device 5 and/or the brake device 6 such that the vehicle speed corresponds to the target vehicle speed. As the travel control unit 12 executes the constant speed control, the vehicle speed of the vehicle 2 is maintained at the recommended vehicle speed. Accordingly, when the vehicle 2 is accelerated from a low speed state (for example, when the vehicle 2 starts moving), the vehicle 2 can be accelerated to the vehicle speed suitable for normal traveling even if the occupant X ends the first operation early.

Further, in a case where not only the first condition but also the second condition is satisfied at the start of the constant speed control (at the end of the first operation), the travel control unit 12 may set the recommended vehicle speed to the target vehicle speed. In a case where the vehicle speed at the end of the first operation is higher than the recommended vehicle speed, the vehicle speed at the end of the first operation is maintained, so that the vehicle speed can match the intention of the occupant X.

The operation element 10 is configured to detect a third operation different from the first operation and the second operation. The third operation is an operation to change the target vehicle speed. The third operation is a contact operation on the facing part 33A or the back part 33B of the ring 33 of the operation element 10. For example, the third operation may be a single tap operation, a double tap operation, a long press operation, or the like. The signal processing unit 14 of the operation element 10 is configured to detect the third operation based on the detection signal from the first capacitive sensor 35 or the second capacitive sensor 36. In a case where the operation element 10 detects the third operation after the travel control unit 12 sets the recommended vehicle speed to the target vehicle speed, the travel control unit 12 (the control device 11) sets one value to the target vehicle speed instead of setting the recommended vehicle speed to the target vehicle speed. The one value is acquired by adding a changing amount corresponding to the third operation to the vehicle speed at detection of the third operation. In this way, the travel control unit 12 gives priority to the value set based on the third operation over the recommended vehicle speed in setting the target vehicle speed. Accordingly, the intention of the occupant X can be reflected in the target vehicle speed.

The travel control unit 12 executes the acceleration/deceleration control according to the following procedure shown in FIG. 8. The acceleration/deceleration control includes the acceleration control, the deceleration control, and the constant speed control. The travel control unit 12 executes the acceleration/deceleration control when the driving mode of the vehicle 2 is set to the manual driving mode. The manual driving mode starts when the vehicle 2 is started or when the driving mode of the vehicle 2 is changed from the autonomous driving mode to the manual driving mode. When the vehicle 2 is started, the target vehicle speed is set to “0” as an initial value of the acceleration/deceleration control. When the driving mode of the vehicle 2 is changed from the autonomous driving mode to the manual driving mode, the current vehicle speed is set to the target vehicle speed as the initial value of the acceleration/deceleration control.

First, the travel control unit 12 determines whether the operation element 10 detects the first operation by the occupant X based on the signal from the force sensor 39 (step S1). In a case where the operation element 10 detects the first operation (in a case where the determination result of step S1 is Yes), the travel control unit 12 executes the acceleration control (step S2). The acceleration control accelerates the vehicle 2 at prescribed acceleration. As described above, the acceleration may be set based on the load applied to the operation element 10 or the moving amount of the operation element 10. The travel control unit 12 continues the acceleration control until the operation element 10 detects the end of the first operation (until the determination result in step S3 becomes Yes).

In a case where the operation element 10 detects the end of the first operation (in a case where the determination result in step S3 is Yes), the travel control unit 12 acquires the recommended vehicle speed from the recommended vehicle speed setting unit 81 (step S4). As described above, the recommended vehicle speed setting unit 81 may set the recommended vehicle speed based on at least one of the vehicle speed of another vehicle traveling around the vehicle 2 and the maximum speed (speed limit) set for the road on which the vehicle 2 is traveling. Alternatively, the recommended vehicle speed setting unit 81 may set the recommended vehicle speed based on the vehicle speed at the past constant speed control. Alternatively, the recommended vehicle speed setting unit 81 may set (acquire) the recommended vehicle speed by adding another prescribed value to the vehicle speed at the end of the first operation.

Next, the travel control unit 12 determines whether the vehicle state satisfies the prescribed condition (step S5). For example, the prescribed condition includes a condition (which corresponds to the first condition) that the vehicle speed at the start of the first operation is equal to or less than the prescribed first threshold. Alternatively, the prescribed condition includes a condition (which corresponds to the first condition and the second condition) that the vehicle speed at the start of the first operation is equal to or less than the prescribed first threshold and the vehicle speed at the end of the first operation is less than the prescribed recommended vehicle speed.

In a case where the vehicle state satisfies the prescribed condition (in a case where the determination result in step S5 is Yes), the travel control unit 12 sets the recommended vehicle speed to the target vehicle speed (step S6). On the other hand, in a case where the vehicle state does not satisfy the prescribed condition (in a case where the determination result in step S5 is No), the travel control unit 12 sets the vehicle speed at the end of the first operation to the target vehicle speed (step S7). After setting the target vehicle speed in step S6 or step S7, the travel control unit 12 executes the constant speed control such that the vehicle speed corresponds to the target vehicle speed (step S8). The constant speed control may be feedback control based on the target vehicle speed.

In a case where the operation element 10 does not detect the first operation by the occupant X in step S1 (in a case where the determination result in step S1 is No), the travel control unit 12 determines whether the operation element 10 detects the second operation by the occupant X based on the signal from the force sensor 39 (step S9). In a case where the operation element 10 detects the second operation (in a case where the determination result in step S9 is Yes), the travel control unit 12 executes the deceleration control (step S10). The deceleration control decelerates the vehicle 2 at prescribed deceleration. As described above, the deceleration may be set based on the load applied to the operation element 10 or the moving amount of the operation element 10. The travel control unit 12 continues the deceleration control until the operation element 10 detects the end of the second operation (until the determination result in step S11 becomes Yes).

In a case where the operation element 10 detects the end of the second operation (in a case where the determination result in step S11 is Yes), the travel control unit 12 sets the vehicle speed at the end of the second operation to the target vehicle speed (step S12). The travel control unit 12 sets the target vehicle speed in step S12, and then executes the constant speed control such that the vehicle speed corresponds to the target vehicle speed (step S8).

Further, in a case where the operation element 10 does not detect the second operation by the occupant X in step S9 (in a case where the determination result in step S9 is No), the travel control unit 12 executes the constant speed control (step S8).

Concrete embodiments of the present invention have been described in the foregoing, but the present invention should not be limited by the foregoing embodiments and various modifications and alterations are possible within the scope of the present invention. For example, the recommended vehicle speed setting unit 81 may set (acquire) the recommended vehicle speed by adding another prescribed value to the vehicle speed at the end of the first operation.

1. A vehicle control system, comprising:
an operation element configured to detect a first operation and a second operation by an occupant, the first operation being an operation in a first direction, the second operation being an operation in a second direction different from the first direction; and
a control device configured to execute acceleration control, deceleration control, and constant speed control when a vehicle moves forward, the acceleration control being control to accelerate the vehicle in response to the first operation, the deceleration control being control to decelerate the vehicle in response to the second operation, the constant speed control being control to accelerate and/or decelerate the vehicle such that a vehicle speed corresponds to a prescribed target vehicle speed in a case where inputs of the first operation and the second operation are absent,
wherein when the first operation ends, the control device sets the vehicle speed at an end of the first operation to the target vehicle speed in a case where a vehicle state does not satisfy a prescribed condition, and sets a prescribed value higher than the vehicle speed at the end of the first operation to the target vehicle speed in a case where the vehicle state satisfies the prescribed condition.

2. The vehicle control system according to claim 1, wherein in a case where the vehicle speed at a start of the first operation is equal to or less than a prescribed first threshold, the control device sets a recommended vehicle speed to the target vehicle speed.

3. The vehicle control system according to claim 1, wherein in a case where the vehicle speed at a start of the first operation is equal to or less than a prescribed first threshold and the vehicle speed at the end of the first operation is less than a prescribed recommended vehicle speed, the control device sets the recommended vehicle speed to the target vehicle speed.

4. The vehicle control system according to claim 1, wherein the operation element is configured to move in the first direction from a neutral position in response to the first operation, and
in a case where a moving amount of the operation element from the neutral position at the end of the first operation is equal to or more than a prescribed second threshold, the control device sets a recommended vehicle speed to the target vehicle speed.

5. The vehicle control system according to claim 2, wherein the control device is configured to set the recommended vehicle speed by adding another prescribed value to the vehicle speed at the end of the first operation.

6. The vehicle control system according to claim 3, wherein the control device is configured to set the recommended vehicle speed by adding another prescribed value to the vehicle speed at the end of the first operation.

7. The vehicle control system according to claim 4, wherein the control device is configured to set the recommended vehicle speed by adding another prescribed value to the vehicle speed at the end of the first operation.

8. The vehicle control system according to claim 2, wherein the control device is configured to set the recommended vehicle speed based on at least one of a vehicle speed of another vehicle traveling around the vehicle and a maximum speed set for a road on which the vehicle is traveling.

9. The vehicle control system according to claim 3, wherein the control device is configured to set the recommended vehicle speed based on at least one of a vehicle speed of another vehicle traveling around the vehicle and a maximum speed set for a road on which the vehicle is traveling.

10. The vehicle control system according to claim 4, wherein the control device is configured to set the recommended vehicle speed based on at least one of a vehicle speed of another vehicle traveling around the vehicle and a maximum speed set for a road on which the vehicle is traveling.

11. The vehicle control system according to claim 2, wherein the control device is configured to set the recommended vehicle speed based on the vehicle speed at the past constant speed control.

12. The vehicle control system according to claim 3, wherein the control device is configured to set the recommended vehicle speed based on the vehicle speed at the past constant speed control.

13. The vehicle control system according to claim 4, wherein the control device is configured to set the recommended vehicle speed based on the vehicle speed at the past constant speed control.

14. The vehicle control system according to claim 2, wherein the operation element is configured to detect a third operation different from the first operation and the second operation, the third operation being an operation to change the target vehicle speed,
wherein in a case where the operation element detects the third operation after the control device sets the recommended vehicle speed to the target vehicle speed, the control device sets one value to the target vehicle speed, the one value being acquired by adding a changing amount corresponding to the third operation to the vehicle speed at detection of the third operation.

15. The vehicle control system according to claim 3, wherein the operation element is configured to detect a third operation different from the first operation and the second operation, the third operation being an operation to change the target vehicle speed,
wherein in a case where the operation element detects the third operation after the control device sets the recommended vehicle speed to the target vehicle speed, the control device sets one value to the target vehicle speed, the one value being acquired by adding a changing amount corresponding to the third operation to the vehicle speed at detection of the third operation.

16. The vehicle control system according to claim 4, wherein the operation element is configured to detect a third operation different from the first operation and the second operation, the third operation being an operation to change the target vehicle speed,
wherein in a case where the operation element detects the third operation after the control device sets the recommended vehicle speed to the target vehicle speed, the control device sets one value to the target vehicle speed, the one value being acquired by adding a changing amount corresponding to the third operation to the vehicle speed at detection of the third operation.

17. The vehicle control system according to claim 2, wherein the operation element is configured to move in the first direction from a neutral position in response to the first operation, and
the control device is configured to set the recommended vehicle speed higher as a moving amount of the operation element from the neutral position at the end of the first operation increases.

18. The vehicle control system according to claim 3, wherein the operation element is configured to move in the first direction from a neutral position in response to the first operation, and
the control device is configured to set the recommended vehicle speed higher as a moving amount of the operation element from the neutral position at the end of the first operation increases.
